(19) United States
(12) Patent Application Publication
(10) Pub. No.: US 2026/0099073 A1
(43) Pub. Date: Apr. 9, 2026

(54) PATTERNED LC DEVICES WITH INDIVIDUAL PHOTOALIGNMENT LAYERS

(71) Applicant: CORNING INCORPORATED, CORNING, NY (US)

(72) Inventors: Allen Wang Bao, Painted Post, NY (US); Chengmingyue Li, Irvine, CA (US); Shenping Li, Painted Post, NY (US); Jianwei Liu, Painted Post, NY (US)

(21) Appl. No.: 19/339,772

(22) Filed: Sep. 25, 2025

Related U.S. Application Data
(60) Provisional application No. 63/705,210, filed on Oct. 9, 2024.

(51) Int. Cl. G02F 1/1337; G02F 1/1347

(52) U.S. Cl. CPC G02F 1/133719; G02F 1/133769; G02F 1/133788; G02F 1/13471

(57) ABSTRACT

A liquid crystal (LC) device and method of forming the device are described. The LC device includes a glass substrate and multiple pairs of photoalignment layers (PALs) and patterned LC elements that are separated by an interstitial layer on the substrate. The interstitial layer has a thickness significantly less than each of the substrate and patterned LC element. Each patterned LC element is a polarization volume grating (PVG) that has a different grating period. The surface of the interstitial layer is super hydrophilic to allow the spread of the next layer of PAL material over the entire surface of the interstitial layer.

### CROSS-REFERENCE TO RELATED APPLICATIONS

This application claims the benefit of priority under 35 U.S.C. § 119 of U.S. Provisional Application No. 63/705,210 filed Oct. 9, 2024, the content of which is incorporated herein by reference in its entirety.

### BACKGROUND

Liquid crystal (LC) devices continue to develop from pioneering work in the late 1960s. Currently, a wide range of LC devices of varying sizes and shapes are used to display images using a varied range of technologies.

### BRIEF DESCRIPTION OF THE FIGURES

The drawings illustrate generally, by way of example, but not by way of limitation, various aspects of the present invention.

FIG. 1A illustrates an example passive patterned liquid crystal element (PLCE).

FIG. 1B illustrates diffraction properties of the PLCE of FIG. 1A.

FIGS. 2A-2D illustrate an example fabrication of a photoaligned LC.

FIG. 3 illustrates an example two-beam interference system.

FIG. 4 illustrates a flowchart of formation of the interstitial layer of FIG. 1A.

FIGS. 5A and 5B illustrate different grating types used in electronic devices.

FIG. 6 illustrates a flowchart of formation of the PLCE.

FIG. 7 illustrates a block diagram of an example electronic device.

FIG. 8 shows a block diagram of an example of an augmented reality (AR)/virtual reality (VR) system.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

An LCD is an optical device that uses one or more layers of LCs combined with one or more polarizers to produce images using multiple pixels. The LC are modulated using an applied voltage to change the twist of the LC molecules and thus transmission of light through the LC layer. Light emitted by a light source, such as a light emitting diode (LED) array, passes through the LC; that is, the LCs themselves do not emit light, the LC layer merely controls the transmission of light therethrough. The LC layer is generally used in conjunction with a backlight or reflector to produce images. Each pixel includes LC molecules aligned between two transparent electrodes, e.g., indium tin oxide (ITO) and polarizers (parallel and perpendicular).

However, an LCD is an active optical device in which voltages are applied to change the transmission characteristics of each pixel. Passive optical devices may be used in other applications and may be indicated as passive PLCEs. In some passive optical devices, a cholesteric liquid crystal (also referred to as a chiral nematic liquid crystal) is used. Cholesteric liquid crystals (CLCs) are materials that have a helical structure and adopt periodical structures - CLCs organize in layers with no positional ordering within layers and are distorted in orientation with respect to neighboring CLC molecules. The CLCs have a periodic orientation variation with molecules that vary according to a predetermined pitch. The orientation of the LC molecules is determined by the alignment at the surfaces, which are perpendicular to each other, so the LC molecules are arranged in a helical structure. Different color filters may be used to generate red, green, and blue subpixels.

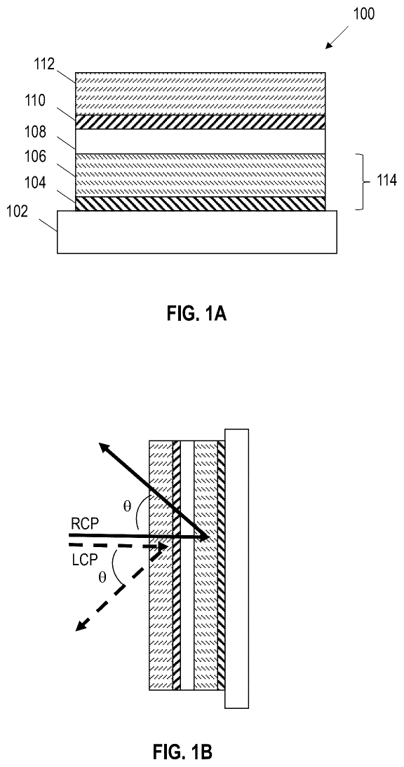

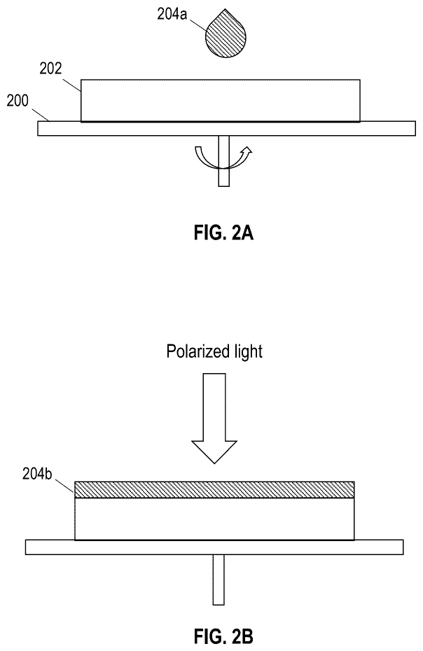

FIG. 1A illustrates an example passive PLCE. In particular, the PLCE 100 may be a PVG, which is a type of patterned cholesteric liquid crystal (PCLC) structure in which the LC molecules are rotated not only based on the underlying surface but also in the depth direction of the film, typically using a chiral LC that spontaneously forms a twisted structure to create a diffraction grating. A polarization volume grating (PVG) may be planar or slanted with respect to the thickness direction of the structure, as indicated by the LC director periodic variation in the horizontal (in plane) and vertical (thickness) directions - or the angle of the linear polarizer formed by the PVG. PVGs are thus self-organized liquid crystal helical structures that exhibit high diffraction efficiency and unique polarization selectivity. PVGs, like other PCLCs, allow for design flexibility as well as the creation of thin flat optics. Unlike conventional optics that utilize optical path difference to create phase modulation, a PCLC generates a desired phase profile by spatially varying the LC orientations along the plane of the surface of the PCLC.

The PLCE 100 shown in FIG. 1A includes multiple thin film layers formed on a transparent substrate 102. Additional layers, such as a reflector or backplane may be present, but are not shown. The transparent substrate 102 may be formed from a rigid material, such as glass, or a flexible material, such as a polymer or plastic. The transparent substrate 102 serves as the base for the PLCE 100 and is typically about 1-2 mm.

A first photoalignment layer (PAL) 104 is formed on the transparent substrate 102. The first PAL 104 is a thin layer of photoalignment material, e.g., an azo dye such as a brilliant yellow (BY) dye. The thickness of the first PAL 104 may be under about 30 nm.

A first PVG 106 is formed on. The first PVG 106 is a first patterned liquid crystal element that uses CLCs. The first PVG 106 includes, for example, a mixture of a chiral agent such as S5011 (2.3 wt. %), initiator such as Irgacure 651 (5 wt. %), and photocurable monomer such as RM257 (92.7 wt. %). The total thickness of the first PVG 106 may be 4 μm. The orientation of the CLCs may be controlled by the first PAL 104. The combination of the first PAL 104 and the first PVG 106 are referred to as a first PCLC element 114.

An interstitial layer 108 may be a thin layer disposed between adjacent PVGs. The interstitial layer 108 may thus be formed on the first PVG 106. The interstitial layer 108 may be formed from a material that is different than the substrate 102. For example, the interstitial layer 108 may be formed from a silane-based material, such as a mixture of Bis(3-trimethoxysilylpropyl) amine (BTSPA, 1%), (3-Acryloxypropyl) trimethoxy silane (ACRTS, 1%), DI water (5%), and Ethanol (93%). The thickness of the interstitial layer 108 is also much thinner than the substrate 102 or the first PVG 106, being sub-micron. In some embodiments, the interstitial layer 108 may be between about 1 nm and about 100 nm. The interstitial layer 108 may be substantially transparent to light of visible frequencies, having a transparency similar to that of the substrate 102 and/or about 95%, 96%, 97%, 98%, 99% or greater transparency.

A second PAL 110 is formed on the interstitial layer 108. The second PAL 110 may be formed from the same or a different as the first PAL 104. The thickness of the second PAL 110 may be similar to that of the first PAL 104, i.e., under about 30 nm.

A second PVG 112 is formed on the second PAL 110. The first PVG 106 is a first patterned liquid crystal element that uses CLCs. The second PVG 112 includes, for example, a mixture of a chiral agent initiator, and photocurable monomer and may have a similar weight ratio as that of the first PVG 106. The total thickness of the second PVG 112 may be similar to the first PVG 106, i.e., about 4 μm. The orientation of the CLCs may be controlled by the second PVG 112.

The total thickness of the PLCE 100, excluding the transparent substrate 102, is primarily determined by the PVGs, which are much thicker than the remaining PAL or interstitial layers (e.g., by at least an order of magnitude). This results in a total thickness of approximately 8-9 μm for the active layers of the PLCE 100 in some embodiments, the typical thickness of patterned LC being about 1 μm to about 10 μm and the interstitial layer being less than about 100 nm. Note that FIG. 1A shows only two PVGs; additional sets of layers may be stacked in the structure in the same manner (i.e., PAL, PVG, interstitial layer) as that shown in FIG. 1A. In other embodiments, a PAL may be disposed on both sides of each PVG, in which case the PALs are similarly aligned. In some applications, a stacked PVG may have space constraints and thus be limited to up to about 10 PVG layers. In such embodiments, the composition and/or thickness of the different interstitial layers may vary, as may the composition and/or thicknesses of the PAL and/or PLCE, so long as the surface energy of the interstitial layer matches the surface requirements for the fabrication of the PAL for the next PVG. The same or different fabrication techniques may be used for similar layers (e.g., PAL layers) within each set of layers. Note that each set of LC/PAL layers may be used to manipulate an independent (e.g., different) wavelength of light; thus, multiple LC/PAL layers may be used to manipulate multiple wavelengths including blue, green and red light, e.g., for AR/VR waveguide and other optical applications.

The orientation of the LC molecules in each PVG is controlled by the underlying PAL. This makes the PCLC exemplified by the PLCE 100 able to realize complex optical functionality while maintaining a high efficiency and ultrathin form factor. Each PVG may have a minimum thickness to obtain a sufficiently high diffraction efficiency (e.g., greater than about 80% or 90%, dependent on the application), and a maximum thickness over which the CLC is no longer able to main alignment with the underlying PAL. Based on the formation process and distinct optical properties, the PCLC is particularly useful for optical devices, emerging displays, and applications requiring a large diffraction angle and small form factor, such as beam steering applications, near-eye optical systems, and head-up displays.

In general, the functional characteristics of individual LC layers are different. The desire to reduce the size of the overall PCLC device and reduce processing steps would promote PAL/CLC layer pairs directly placed on each other. However, the different surface properties between the CLC layer and the requirements for fabricating the PAL limit the possibility of direct stacking of multiple PCLC elements (i.e., PAL1, PVG1, PAL2, PVG2, PAL3, etc.) for a compact, lightweight, and multifunctional LC device. To this end, interstitial layers are used to stack PCLC elements to permit fabrication of a compact and lightweight photonic device with multiple functions. The use of the interstitial layers rather than bonding bulk substrates mitigates the use of an additional adhesive layer and the resulting scattering and refraction caused by multiple interfaces. The interstitial layer is thus compatible with the CLC to generate desirable properties, and, while the same material as the substrate (e.g., glass) may be used, there may be significant issues with optical performance for glass layers that are able to be fabricated (i.e., too thick) and processing difficulties if thinner glass layers are fabricated (e.g., the additional adhesive layer or processing temperatures used to form glass directly on the LC layer).

FIG. 1B illustrates diffraction properties of the PLCE of FIG. 1A. As shown, the diffraction properties of the stacked PVGs are different. In particular, the first PVG is sensitive to right-handed circularly polarized (RCP) and the second PVG is sensitive to left-handed circularly polarized (LCP) light, although this is merely exemplary. The first PVG and the second PVG may also diffract incident light of the different polarizations at independent angles to opposite directions due to different grating designs. As shown in the example of FIG. 1B, the first PVG and the second PVG diffract incident light of the different polarizations at the same angle (θ) to opposite directions.

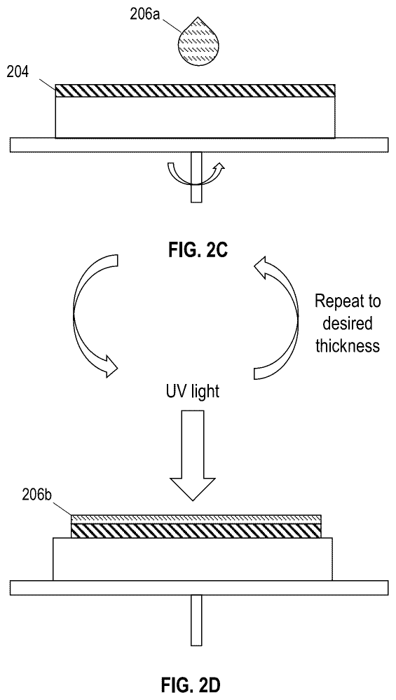

FIGS. 2A-2D illustrate an example fabrication of a photoaligned LC. In FIG. 2A, the substrate 202 is disposed on a chuck 200. The substrate 202 may be cleaned and fixed to the chuck 200 using a vacuum or other mechanical attachment. The chuck 200 may rotate at a predetermined speed while photoalignment material 204a, such as an azo dye, is dissolved and spin-coated on the substrate 202. As shown in FIG. 2B, a PAL 204 is then fabricated by irradiating the initial photoalignment layer 204b, formed by spreading of the photoalignment material 204a over the surface of the substrate 202, with polarized light to create a designed pattern of the LC optical element to be deposited.

In FIG. 2C, LC material 206a is deposited on the PAL 204 by directly spin-coating the LC material 206a on the PAL 204. The LC molecules on the PAL surface change their orientations to match the patterned dye molecules on the surface of the PAL 204. A thin layer 206b of a patterned LC is then fabricated at FIG. 2D by curing the LC material 206a that has spread over the entire surface of the PAL 204. The thin film may have a submicron thickness, e.g., about 0.5 μm. The curing process uses ultraviolet (UV) light to fix the LC orientations for further alignment. The deposition of additional LC material 206a (FIG. 2C) and curing to form an additional thin layer 206b of patterned LC on the underlying thin layer 206b of patterned LC (FIG. 2D) is repeated until a desired thickness (e.g., several μm) of patterned LC is reached. The repeated fabrication steps in thin films permits the curing process to be relatively quick and penetrate the entire volume of uncured material to achieve the designed phase modulation. Compared to other approaches to obtain patterned LC, such as mechanical rubbing and nanoimprinting lithography, photoalignment is able to provide high resolution, and is simple, non-contact, and low cost. In some embodiments, each pattern may be independent (e.g., different) of each other pattern.

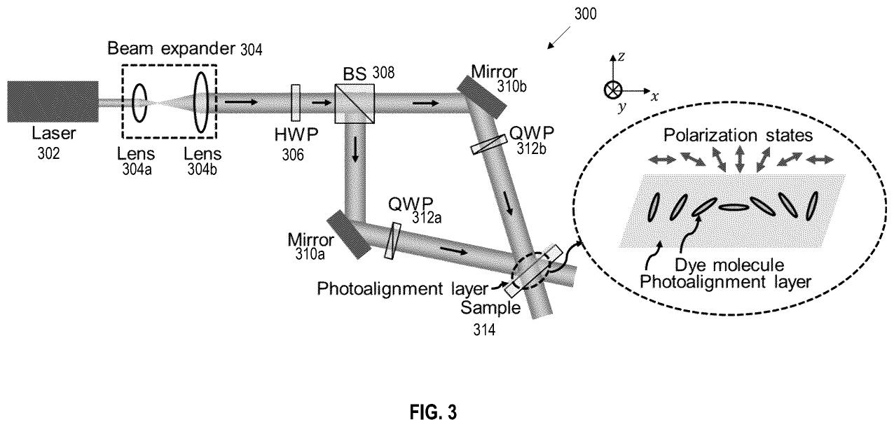

FIG. 3 illustrates an example two-beam interference system. The two-beam interference system 300 is used during fabrication of the PLCE. In particular, the two-beam interference system 300 is used for patterning of the PAL for the alignment of the LC. The two-beam interference system 300 generates an optical field with periodically changed polarization states. A laser beam from a laser 302 of the two-beam interference system 300 impinges on a beam expander 304. The beam expander 304 contains multiple lenses 304a, 304b that increase the beam diameter before the beam impinges on a half-wave plate (HWP) 306, which rotates the polarization direction of linearly polarized light to achieve a vertical polarization. The beam with rotated polarization is divided into two beams by a beam splitter (BS) 308. Mirrors 310a, 310b are used to reflect the light into a sample 314 with a predetermined angle. Two quarter-wave plates (QWPs) 312a, 312b are used to convert the linear polarization into LCP and RCP. A glass substrate coated with dye material is mounted at the intersection of the two beams to form a PAL, as shown in FIG. 2B. The dye molecules under the light illumination rotate to a direction perpendicular to the polarization state of the light to minimize the chemical energy of the dye molecules for thermal stability. By adjusting the divergence angle and intersection angle of the intersecting beams, different optical interference patterns can be created for fabricating the PLCE. In other embodiments, a single beam writing system may be used a spatial light modulator and/or other advanced optics are used.

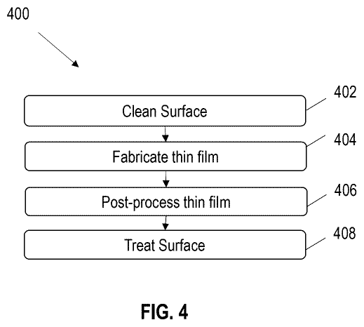

FIG. 4 illustrates a flowchart of formation of the interstitial layer of FIG. 1A. Only general steps are shown in the method 400 of FIG. 4, additional steps may be present (e.g., multiple types of cleaning or treatment) but are not shown for convenience.

Once the PAL and LC element has been fabricated, at operation 402, the surface of the fabricated LC element is cleaned. The cleaning methods may include one or more of UV ozone (UVO)-zone exposure, plasma treatment or others.

After the LC element surface has been cleaned, a thin film is fabricated on top of the LC element surface at operation 404. To fabrication the thin film, a solution or other material may be one or more of spin-coated, dip-coated, chemical vapor deposited, or int-jet printed, among others, on the LC element surface. The material/solution of the thin film is chosen to mimic the properties of the substrate 102 in FIG. 1A for the fabrication of PAL to be fabricated on the thin film. In some cases, the same material as used for the substrate 102 may be used as the thin film, although this is not generally able to be provided for a substrate formed from glass. The thickness of the thin film may be dependent on the fabrication conditions, such as spin-coating speed and time, concentration of the main material forming the thin film, and viscosity of the thin film solution, among others.

After deposition of the thin film, one or more post-processing operations are used at operation 406 to ensure attachment of the thin film on the surface of the LC element. Depending on the thin film fabrication method and the material properties, the post-processing operations may include one or more of baking the thin film or UV-curing the thin film, for example.

Subsequently, one or more surface treatment methods are used at operation 408 to further modify the surface of the thin film to match the surface energy of the attached thin film to the surface requirements for the fabrication of the PAL for the next LC element. Without the interstitial layer, the surface of the patterned LC shows strong hydrophobicity, resulting in fabrication issues in deposition of later layers (e.g., the next PAL layer). Merely cleaning the surface of the patterned LC results in strong hydrophobicity and in addition may cause further issues with the properties at surface of the patterned LC. After the introduction of the interstitial layer followed by the surface treatment, the surface of the interstitial layer becomes super hydrophilic (i.e., water dropped onto the surface forms essentially no contact angle), which is one of the conditions for the fabrication of the PAL for the PLCE. This is to say that the surface energy of the interstitial layer after the surface treatment is close to the surface energy of the surface of the transparent substrate and PAL, which can be characterized by measuring a water contact angle (about 5° for glass as the transparent substrate and about 6° for the PAL). The water contact angle for the LC is about 72°. In some embodiments, for the surface energy of the interstitial layer after treatment to match that of the PAL, the surface energy of the interstitial layer after treatment is within about 7% the surface energy of the PAL.

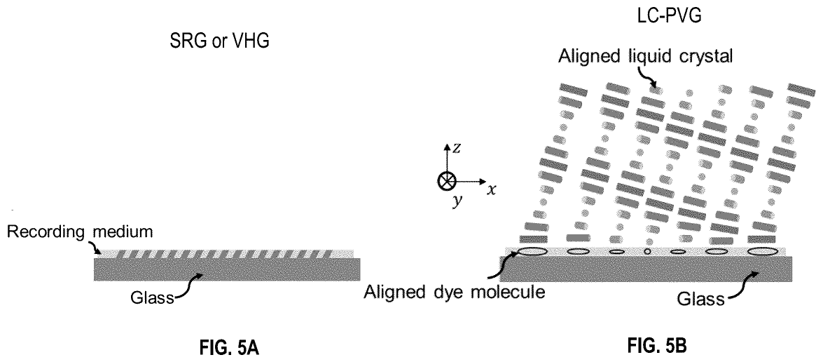

FIGS. 5A and 5B illustrate different grating types used in electronic devices. FIG. 5A shows surface-relief gratings (SRGs) or volume holographic gratings (VHGs) in which a recording medium containing the grating is formed on a substrate, which may be formed from glass. FIG. 5B shows an LC-PVG having a slanted grating. FIG. 5B shows an example of the PLCE 100 in which only a single PCLC element (the PAL and LC-PVG layers) is present on the glass substrate. Either type of grating in FIG. 5A or 5B, which may be used in combination in some embodiments, provides a diffractive element and waveguide that may be able to be used in different applications, for example AR/VR applications. However, compared to diffraction gratings used in current commercial AR/VR devices, the LC-PVG shown in FIG. 5B includes a spatially distributed optical axis of anisotropic LCs along both the surface and thickness direction of the material, while the SRGs or VHGs shown in FIG. 5A are limited to a one-dimensional periodic structure. The three-dimensional spiral structure of the LC provides a large phase modulation, unique polarization sensitivity, and strong reflection that can be exploited in widespread applications, such as beam steering, integrated photonics devices, image processing, and displays.

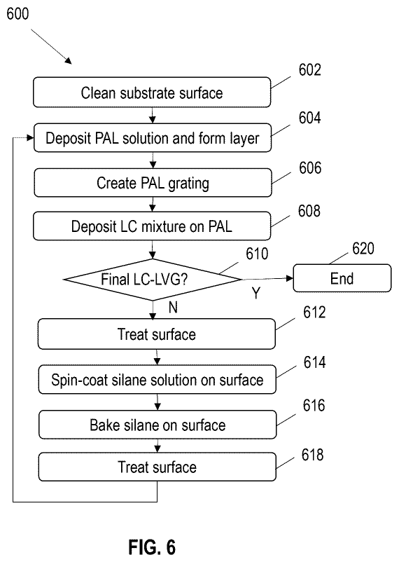

FIG. 6 illustrates a flowchart of formation of the PLCE. Some of the operations in the method 600 of formation of the PLCE described herein are not show for brevity.

At operation 602, the surface of a glass substrate is cleaned using UVO-zone and/or plasma treatment for example. The substrate may be mounted on a chuck before or after the cleaning.

A PAL is fabricated using a BY dye (dye content≥50%) solution in a solvent such as Dimethylformamide (DMF, concentration of 0.6 wt. %). Ultrasound sonification of a predetermined period, e.g., 15 minutes, is used to agitate particles in the mixture. The solution is then filtered using a 0.22-μm syringe filter, for example, before dropping onto the cleaned glass substrate at operation 604. After deposition of the PAL mixture, a dye layer is spin-coated onto the glass substrate at operation 604. The chuck may rotate, for example, at 800 rpm for 5 s and then 3,000 rpm for 30 s.

Once the dye layer covers the underlying material, a two-beam recording system is used to create the alignment of the PAL molecules, and thus the PAL grating, at operation 606. The laser used may be a 450 nm blue laser or a green laser having a wavelength of 532 nm. The use of a low-cost, reliable green laser is laser instead of a blue laser may permit mass production of LC-PVG structures. As above, the dye layer may be placed under the two-beam recording system and exposed to both an LCP and the RCP beam. The PAL may be recorded with an intensity of a single writing beam of 300 mW/cm² for 10 min. The writing angle θ, that is, half of the intersection angle of two beams, may be set to a first angle (e.g., 23°), corresponding to an x-axis grating period Λ=680.8 nm for the LC-PVG according to the grating equation of 2Λ sin θ=λ.

After the fabrication of the PAL, a LC precursor solution may be prepared. One such LC precursor solution may include a 2.3 wt. % chiral agent (e.g., S5011), 5 wt. % initiator, and 92.7 wt. % photocurable monomer, which may be diluted in toluene with a dilution ratio of 1:9. The LC processor mixture may again be treated with ultrasound sonification until a clear solution is obtained, e.g., for about 15 mins or longer. The LC precursor may be spin-coated onto the PAL at operation 608 with the chuck rotating at 1500 rpm for 30 s in a dark environment, resulting in a thin layer of PVG formed on the substrate. The molecules of LC birefringent materials are formed a spiral configuration, aligned by the PAL and helix twist caused by the chiral dopant after the partial evaporation of the solvent. The coated substrate may then be cured with a 365 nm UV light, e.g., at a dosage of 5.5 J/cm² for 30 s in a nitrogen environment. The LC spin-coating and curing processes may be repeated a predetermined number of times (e.g., 8) to achieve predetermined thickness (e.g., about 4 μm) to result in a high efficiency diffraction grating.

If, at operation 610, no more LC-LVG layers are to be formed (i.e., it is determined that this is the final LC-LVG), the process terminates at operation 620. If further LC-LVG layers are to be formed, the process continues to operation 612.

To fabricate the second LC-PVG on top of the first LC-PVG, the second LC-PVG may be stacked on top of the LC-PVG surface. As above, at operation 612 the surface of the LC-PVG layer may be treated to clean the surface of the first LC-PVG. For example, a 10-min plasma treatment may be used to clean the surface of the first LC-PVG.

After cleaning the surface of the first LC-PVG, a silane material that is able to mimic the properties of the substrate after proper surface treatments may be prepared. The silane material may be composed of Bis(3-trimethoxysilylpropyl) amine (BTSPA, 1%), (3-Acryloxypropyl) trimethoxy silane (ACRTS, 1%), DI water (5%) and Ethanol (93%). At operation 614, the silane solution may be deposited on the underlying LC-PVG. For example, the silane solution may be spin-coated on the underlying LC-PVG at a speed of 2000 rpm for 45 s. In other embodiments, the material used to form the interstitial layer may include one or more of: Bis(3-trimethoxysilylpropyl) amine, (3-Acryloxypropyl) trimethoxy silane, acetoxymethyltriethoxysilane, acetoxytrimethylsilane, acryloxymethyltrimethoxysilane, 6-azidosulfonylhexyltriethoxysilane, hexadecyltrimethoxysilane, aminosupersilane, dipropargylamine, tetrakis(trimethylsilyl)silane, titanium (IV) butoxide, or titanium acetylacetonates. The spin rate during spin coating may range from about 500 rpm to about 10,000 rpm, and the time may range from about 10 s to about 240 s. Other coating processes that may be used to provide the interstitial layer may include dip coating, spray coating, vapor coating, and/or slot die coating.

At operation 616, after the silane material has been deposited on the surface of the LC-PVG, the silane material may be cured. For example, the silane on the LC-PVG surface may be baked at 105° C. for 10 min.

The silane may then be treated at operation 618 to form the interstitial layer. For example, a 10 min plasma treatment may be used to treat the surface. After the plasma treatment, the surface of the interstitial layer is super hydrophilic to allow the spread of the next layer of PAL material over the entire surface of the interstitial layer.

Note that each LC-PVG may be fabricated using a writing angle that is independent of the writing angle used to form each other LC-PVG. Thus, for example, the writing angle used to form the second LC-PVG may be, for example, 35°, corresponding to an x-axis grating period of 464.5 nm. The LC precursor for other LC-PVGs may be different as well. For example, the LC precursor for the second LC-PVG may be mixture of a different chiral agent (R5011 instead of S5011 used in the first LC-PVG), initiator, and photocurable monomer having a weight ratio of 1.95:5:93.05, with a dilution ratio is 1:9 in toluene.

An optical system may be used to measure the diffraction efficiency for different reading angles of the structure described in FIG. 6. Collimated linearly polarized light from a 532-nm laser was adjusted by a QWP to be RCP or LCP and then incident into the sample. A power meter was used to measure the power of diffracted beam reflected by the sample. The sample was mounted in a rotation stage to adjust the reading angle. The diffraction efficiency is defined as the power ratio of diffracted light to incident light. The measured diffraction efficiency of the stacked LC-PVG device as a function of reading angle with RCP and LCP light illuminations at the wavelength of 533 nm indicated that the maximum diffraction efficiency of the device with LCP illumination (about 35%) was not as high as with RCP illumination (about 12%). This may be due to imperfections in the interstitial layer (such as uniformity), causing the diffraction efficiency of the second LC-PVD to be lower than the diffraction efficiency of the first LC-PVD.

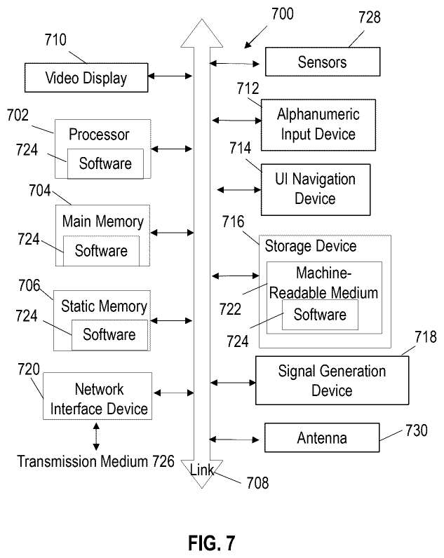

FIG. 7 illustrates a block diagram of an example electronic device. The electronic device 700 may operate as a standalone device or may be connected (e.g., networked) to other devices and may use the stacked structure described herein. The electronic device 700 may be a user equipment (UE) such as a portable communication device or AR/VR device. A portable communication device may include a mobile phone, a smartphone, a laptop computer, a tablet computer, a web appliance, or any machine capable of executing instructions (sequential or otherwise) that specify actions to be taken by that machine that permit the machine to communicate over mmWave signals. The electronic device 700 may have additional components not shown in FIG. 7 and/or some of the components shown in FIG. 7 may not be present.

The electronic device 700 may include a hardware processor 702 (e.g., a central processing unit (CPU), a graphics processing unit (GPU), a hardware processor core, or any combination thereof), a main memory 704, and a static memory 706, some or all of which may communicate with each other via an interlink (e.g., bus) 708.

Specific examples of main memory 704 include Random Access Memory (RAM), and semiconductor memory devices, which may include, in some embodiments, storage locations in semiconductors such as registers. Specific examples of static memory 706 include non-volatile memory, such as semiconductor memory devices (e.g., Electrically Programmable Read-Only Memory (EPROM), Electrically Erasable Programmable Read-Only Memory (EEPROM)) and flash memory devices.

The electronic device 700 may further include a display device 710, an input device 712 (e.g., a keyboard), and a user interface (UI) navigation device 714 (e.g., a mouse). In an example, the display device 710, the input device 712, and the UI navigation device 714 may be a touch screen display. The electronic device 700 may additionally include a storage device (e.g., drive unit) 716, a signal generation device 718 (e.g., a speaker), a network interface device 720, one or more antennas 730, and one or more sensors 728, such as a global positioning system (GPS) sensor, compass, accelerometer, or other sensors. The electronic device 700 may include a transmission medium 726, such as a serial bus (e.g., universal serial bus (USB)), parallel, or other wired or wireless (e.g., infrared (IR), near field communication (NFC), etc.) connection to communicate or control one or more peripheral devices (e.g., a printer, card reader, television). In some embodiments, the hardware processor 702 and/or instructions 724 may comprise processing circuitry and/or transceiver circuitry.

The storage device 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or the hardware processor 702 during execution thereof by the electronic device 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store instructions 724. The term “machine-readable medium” may include any medium that is capable of storing, encoding, or carrying instructions for execution by electronic device 700 and that causes the electronic device 700 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

The instructions 724 may further be transmitted or received over a communications network using a transmission medium 726 via the network interface device 720 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP family of standards including Long Term Evolution (LTE) and 4G/5G/6G standards, a Universal Mobile Telecommunications System (UMTS) family of standards, peer-to-peer (P2P) networks, among others.

In an example, the network interface device 720 may include one or more physical jacks (e.g., Ethernet, coaxial, or phone jacks) or one or more antennas to connect to the communications network. In an example, the network interface device 720 may include one or more antennas 730 to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques. The term “transmission medium” shall be taken to include any intangible medium that is capable of carrying instructions for execution by the electronic device 700, which include digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, flash memory, etc.

The hardware processor 702 may use various circuity to send and receive communication via the antennas 730. Although not exclusive, such circuitry may include mixers (such as up- and down-conversion mixer circuitry configured to convert signals between baseband and the transmission frequency), amplifiers configured to amplify signals for communication, filters configured to filter out spurious signals, and drivers to drive the antennas 730.

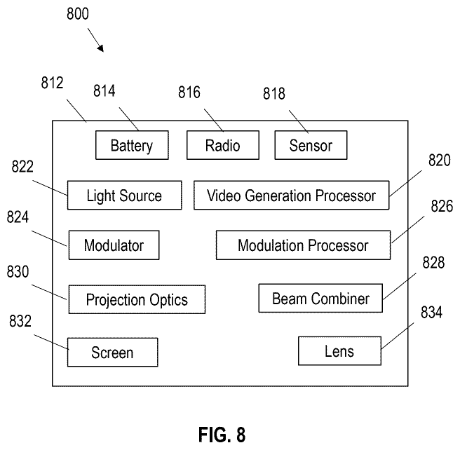

FIG. 8 shows a block diagram of an example of an AR/VR system. The system 800 can include a wearable housing 812, such as a headset or goggles. The wearable housing 812 can mechanically support and house the elements detailed below. In some examples, one or more of the elements detailed below may be included in one or more additional wearable housings that can be separate from the wearable housing 812 and couplable to the wearable housing 812 wirelessly and/or via a wired connection. For example, a separate wearable housing may reduce the weight of wearable goggles, such as by including batteries, radios, and other elements. The wearable housing 812 may include one or more batteries 814, which can electrically power any or all of the elements detailed below. The wearable housing 812 may include circuitry that can electrically couple to an external power supply, such as a wall outlet, to recharge the batteries 814. The wearable housing 812 may include one or more radios 816 to communicate wirelessly with a server or network via a suitable protocol, such as WiFi.

The system 800 may include one or more sensors 818, such as optical sensors, audio sensors, tactile sensors, thermal sensors, gyroscopic sensors, time-of-flight sensors, triangulation-based sensors, proximity sensors, eye-tracking sensors, and others. In some examples, one or more of the sensors can sense a location, a position, and/or an orientation of a user. In some examples, one or more of the sensors 818 can produce a sensor signal in response to the sensed location, position, and/or orientation of the wearer. The sensor signal can include sensor data that corresponds to a sensed location, position, and/or orientation. For example, the sensor data may include a depth map of the surroundings. In some examples, such as for an AR system, one or more of the sensors 818 can capture a real-time video image of the surroundings proximate a user.

The system 800 may include one or more video generation processors 820. The one or more video generation processors 820 can receive scene data that represents a three-dimensional scene, such as a set of position coordinates for objects in the scene or a depth map of the scene. This data may be received from a server and/or a storage medium. The one or more video generation processors 820 can receive one or more sensor signals from the one or more sensors 818. In response to the scene data, which represents the surroundings, and at least one sensor signal, which represents the location and/or orientation of the user with respect to the surroundings, the one or more video generation processors 820 can generate at least one video signal that corresponds to a view of the scene. In some examples, the one or more video generation processors 820 may generate two video signals, one for each eye of the user, that represent a view of the scene from a point of view of the left eye and the right eye of the user, respectively. In some examples, the one or more video generation processors 820 may generate more than two video signals and combine the video signals to provide one video signal for both eyes, two video signals for the two eyes, or other combinations.

The system 800 may include one or more light sources 822 that provide light for a display of the system 800. Suitable light sources 822 may include LEDs, for example. The one or more light sources 822 may include light-producing elements having different colors or wavelengths. For example, a light source may include a red light-emitting diode that emits red light, a green light-emitting diode that emits green light, and a blue light-emitting diode that emits blue right. The red, green, and blue light combine in specified ratios to produce any suitable color that is visually perceptible in a visible portion of the electromagnetic spectrum. Each pixel of the system may include 3 or more light emitters (such as a white emitting light emitters, in which a wavelength-converting layer that contains phosphor particles converts the light from the light emitter to white light).

The system 800 can include one or more modulators 824. The modulators 824 may be implemented in one of at least two configurations. In a first configuration, the modulators 824 may include circuitry that modulate the light sources 822 directly. For example, the light sources 822 may include an array of LEDs (such as light emitters), and the modulators 824 may directly modulate the electrical power, electrical voltage, and/or electrical current directed to each light-emitting diode in the array to form modulated light. The modulation may be performed in an analog manner (current) and/or a digital manner (PWM). In some examples, the light sources 822 may include an array of red light-emitting diodes, an array of green light-emitting diodes, and an array of blue light-emitting diodes, and the modulators 824 may directly modulate the red light-emitting diodes, the green light-emitting diodes, and the blue light-emitting diodes to form the modulated light to produce a specified image.

In a second configuration, the modulators 824 may include a modulation panel, such as a liquid crystal panel. The light sources 822 may produce uniform illumination, or nearly uniform illumination, to illuminate the modulation panel. The modulation panel can include pixels. Each pixel can selectively attenuate a respective portion of the modulation panel area in response to an electrical modulation signal to form the modulated light. In some examples, the modulators 824 may include multiple modulation panels that modulate different colors of light. For example, the modulators 824 may include a red modulation panel that attenuates red light from a red light source such as a red light-emitting diode, a green modulation panel that attenuates green light from a green light source such as a green light-emitting diode, and a blue modulation panel that attenuates blue light from a blue light source such as a blue light-emitting diode.

In some examples of the second configuration, the modulators 824 may receive uniform white light or nearly uniform white light from a white light source, such as a white-light light-emitting diode. The modulation panel may include wavelength-selective filters on each pixel of the modulation panel. The panel pixels may be arranged in groups (such as groups of three or four), where each group forms a pixel of a color image. For example, each group may include a panel pixel with a red color filter, a panel pixel with a green color filter, and a panel pixel with a blue color filter. Other suitable configurations can also be used.

The system 800 may include one or more modulation processors 826, which receive a video signal, such as from the one or more video generation processors 820, and, in response, produce an electrical modulation signal. For configurations in which the modulators 824 directly modulate the light sources 822, the electrical modulation signal may drive the light sources 822. For configurations in which the modulators 824 include a modulation panel, the electrical modulation signal may drive the modulation panel.

The system 800 may include one or more beam splitters 828 (also known as beam combiners), which combine light beams of different colors to form a single multi-color beam. For configurations in which the light sources 822 may include multiple light-emitting diodes of different colors, the system 800 may include one or more wavelength-sensitive (e.g., dichroic) beam splitters 828 that combine the light of different colors to form a single multi-color beam.

The system 800 may direct the modulated light toward the eyes of the viewer in one of at least two configurations. In a first configuration, the system 800 may function as a projector, and may include suitable projection optics 830 that project the modulated light onto one or more screens 832. The screens 832 may be located a suitable distance from an eye of the user. The system 800 may optionally include one or more lenses 834 that can locate a virtual image of a screen 832 at a suitable distance from the eye, such as a close-focus distance, such as 500 mm, 750 mm, or another suitable distance. In some examples, the system 800 may include a single screen 832, such that the modulated light may be directed toward both eyes of the user. In some examples, the system 800 may include two screens 832, such that the modulated light from each screen 832 may be directed toward a respective eye of the user. In some examples, the system 800 may include more than two screens 832. In a second configuration, the system 800 may direct the modulated light directly into one or both eyes of a viewer. For example, the projection optics 830 may form an image on a retina of an eye of the user, or an image on each retina of the two eyes of the user. In some cases, the projection optics 830 (or other elements of the system 800) may include the LC-PVG structures described herein.

For some configurations of AR systems, the system 800 may include at least a partially transparent display, such that a user may view the user's surroundings through the display. For such configurations, the AR system may produce modulated light that corresponds to the augmentation of the surroundings, rather than the surroundings itself. For example, in the example of a retailer showing a chair, the AR system may direct modulated light, corresponding to the chair but not the rest of the room, toward a screen or toward an eye of a user.

### EXAMPLES

Example 1 is a stacked liquid crystal device, comprising: a substrate; a first photoalignment layer (PAL) disposed on the substrate; a first patterned liquid crystal (LC) element disposed on the first PAL; an interstitial layer disposed on the first patterned LC element; a second PAL disposed on the interstitial layer, the interstitial layer comprising a material having a surface energy matching that of the second PAL; and a second patterned LC element disposed on the second PAL.

In Example 2, the subject matter of Example 1 includes, wherein patterns of the first patterned LC element are independent of patterns of the second patterned LC element.

In Example 3, the subject matter of Examples 1-2 includes, wherein the interstitial layer is formed from a different material than the substrate.

In Example 4, the subject matter of Examples 1-3 includes, wherein: the interstitial layer has a thickness between about 1 nm and about 100 nm; and each of the first patterned LC element and second patterned LC element has a thickness between about 1 μm and about 10 μm.

In Example 5, the subject matter of Examples 1-4 includes, wherein a surface of the second patterned LC element opposite a surface in contact with the second PAL is super hydrophilic.

In Example 6, the subject matter of Examples 1-5 includes, wherein the interstitial layer is substantially transparent to light of visible frequencies.

In Example 7, the subject matter of Examples 1-6 includes, wherein each of the first patterned LC element and second patterned LC element is a polarization volume grating (PVG) that has a spatially distributed optical axis of anisotropic LCs along both a surface and thickness direction of the respective first patterned LC element and second patterned LC element.

In Example 8, the subject matter of Example 7 includes, wherein the first PVG and second PVG have different grating periods.

In Example 9, the subject matter of Examples 7-8 includes, wherein the first PVG and second PVG are sensitive to different orthogonal circular polarization states.

In Example 10, the subject matter of Examples 1-9 includes, wherein the interstitial layer comprises a treated silane material and the substrate comprises glass.

Example 11 is a method of fabricating a stacked liquid crystal device, comprising: forming a first photoalignment layer (PAL) on a substantially transparent substrate; forming a first patterned liquid crystal (LC) element on the first PAL; forming an interstitial layer on the first patterned LC element, the interstitial layer comprising a material having a surface energy matching that of the first PAL; treating a surface of the interstitial layer; forming a second PAL disposed on the interstitial layer; and forming a second patterned LC element disposed on the second PAL.

In Example 12, the subject matter of Example 11 includes, wherein: forming the first PAL comprises: preparing a first photoalignment material solution; filtering the first photoalignment material solution through a first syringe filter to form a first filtered photoalignment solution; coating the first filtered photoalignment solution onto the substrate to form a coated substrate; and exposing the first filtered photoalignment solution on the coated substrate to first patterned polarized light using a two-beam recording system to create a pattern of the first patterned LC element; and forming the second PAL comprises: preparing a second photoalignment material solution; filtering the second photoalignment material solution through a second syringe filter to form a second filtered photoalignment solution; coating the second filtered photoalignment solution onto the first patterned LC element to form a coated first patterned LC element; and exposing the second filtered photoalignment solution on the coated first patterned LC element to patterned polarized light using the two-beam recording system to create a pattern of the second patterned LC element.

In Example 13, the subject matter of Example 12 includes, wherein the two-beam recording system comprises a green laser and exposing the first filtered photoalignment solution and the second filtered photoalignment solution comprises exposing the first filtered photoalignment solution and the second filtered photoalignment solution to the green laser.

In Example 14, the subject matter of Examples 12-13 includes, wherein exposing the first filtered photoalignment solution and the second filtered photoalignment solution comprises exposing one of the first filtered photoalignment solution and the second filtered photoalignment solution to a left-handed circularly polarized (LCP) beam and exposing another of the first filtered photoalignment solution and the second filtered photoalignment solution to a right-handed circularly polarized (RCP) beam.

In Example 15, the subject matter of Examples 12-14 includes, wherein: a writing angle of the two-beam recording system is half of an intersection angle of beams of the two-beam recording system, a first writing angle used to expose the first filtered photoalignment solution is different from a second writing angle used to expose the second filtered photoalignment solution, and the first writing angle corresponds to a first x-axis grating period of the first patterned LC element and the second writing angle corresponds to a second x-axis grating period of the second patterned LC element, the first x-axis grating period and the second x-axis grating period are different.

In Example 16, the subject matter of Examples 11-15 includes, wherein forming each of the first patterned LC element and second patterned LC element comprises: preparing a LC precursor mixture that includes a chiral agent, an initiator, and a photocurable monomer diluted in toluene; treating the LC precursor mixture with ultrasound sonification to form a treated LC precursor mixture; coating the treated LC precursor mixture onto an underlying layer to form a respective coated layer; curing the respective coated layer with ultraviolet light; and repeating the coating and curing until a predetermined thickness is achieved for the respective first patterned LC element and second patterned LC element.

In Example 17, the subject matter of Examples 11-16 includes, wherein forming the interstitial layer comprises: cleaning a surface of the first patterned LC element on which the interstitial layer is to be deposited; preparing a silane-based interstitial layer solution; coating the interstitial layer solution on the first patterned LC element to form an uncured interstitial layer; baking the uncured interstitial layer; and treating a surface of the uncured interstitial layer after baking to form a super hydrophilic surface.

In Example 18, the subject matter of Examples 11-17 includes, wherein forming each of the first PAL, the first patterned LC element, the interstitial layer, the second PAL, and the second patterned LC element comprises spin-coating, dip-coating, chemical vapor deposition, or ink-jet printing a respective material on an underlying layer.

Example 19 is a method of fabricating a stacked liquid crystal device, comprising: depositing a first photoalignment layer (PAL) on a substrate; forming a first polarization volume grating (PVG) on a first photoalignment layer (PAL), the first PVG having a first grating period; depositing an interstitial layer on the first PVG, the interstitial layer formed from a different material than the substrate; treating a surface of the interstitial layer to form a super hydrophilic surface; depositing a second PAL on the super hydrophilic surface, the super hydrophilic surface matching a surface energy of the second PAL; and forming a second PVG on the second PAL, the second PVG having a second grating period that is independent of the first grating period.

In Example 20, the subject matter of Example 19 includes, wherein the interstitial layer comprises a silane material and has a thickness between about 1 nm and about 100 nm.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Exemplary Aspects

The following exemplary aspects are provided, the numbering of which is not to be construed as designating levels of importance:

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A stacked liquid crystal device, comprising:
a substrate;
a first photoalignment layer (PAL) disposed on the substrate;
a first patterned liquid crystal (LC) element disposed on the first PAL;
an interstitial layer disposed on the first patterned LC element;
a second PAL disposed on the interstitial layer, the interstitial layer comprising a material having a surface energy matching that of the second PAL; and
a second patterned LC element disposed on the second PAL.

2. The stacked liquid crystal device of claim 1, wherein patterns of the first patterned LC element are independent of patterns of the second patterned LC element.

3. The stacked liquid crystal device of claim 1, wherein the interstitial layer is formed from a different material than the substrate.

4. The stacked liquid crystal device of claim 1, wherein:
the interstitial layer has a thickness between about 1 nm and about 100 nm; and
each of the first patterned LC element and second patterned LC element has a thickness between about 1 μm and about 10 μm.

5. The stacked liquid crystal device of claim 1, wherein a surface of the second patterned LC element opposite a surface in contact with the second PAL is super hydrophilic.

6. The stacked liquid crystal device of claim 1, wherein the interstitial layer is substantially transparent to light of visible frequencies.

7. The stacked liquid crystal device of claim 1, wherein each of the first patterned LC element and second patterned LC element is a polarization volume grating (PVG) that has a spatially distributed optical axis of anisotropic LCs along both a surface and thickness direction of the respective first patterned LC element and second patterned LC element.

8. The stacked liquid crystal device of claim 7, wherein the first PVG and second PVG have different grating periods.

9. The stacked liquid crystal device of claim 7, wherein the first PVG and second PVG are sensitive to different orthogonal circular polarization states.

10. The stacked liquid crystal device of claim 1, wherein the interstitial layer comprises a treated silane material and the substrate comprises glass.

11. A method of fabricating a stacked liquid crystal device, comprising:
forming a first photoalignment layer (PAL) on a substantially transparent substrate;
forming a first patterned liquid crystal (LC) element on the first PAL;
forming an interstitial layer on the first patterned LC element, the interstitial layer comprising a material having a surface energy matching that of the first PAL;
treating a surface of the interstitial layer;
forming a second PAL disposed on the interstitial layer; and
forming a second patterned LC element disposed on the second PAL.

12. The method of claim 11, wherein:
forming the first PAL comprises:
preparing a first photoalignment material solution;
filtering the first photoalignment material solution through a first syringe filter to form a first filtered photoalignment solution;
coating the first filtered photoalignment solution on the substrate to form a coated substrate; and
exposing the first filtered photoalignment solution on the coated substrate to first patterned polarized light using a two-beam recording system to create a pattern of the first patterned LC element; and
forming the second PAL comprises:
preparing a second photoalignment material solution;
filtering the second photoalignment material solution through a second syringe filter to form a second filtered photoalignment solution;
coating the second filtered photoalignment solution onto the first patterned LC element to form a coated first patterned LC element; and
exposing the second filtered photoalignment solution on the coated first patterned LC element to patterned polarized light using the two-beam recording system to create a pattern of the second patterned LC element.

13. The method of claim 12, wherein the two-beam recording system comprises a green laser and exposing the first filtered photoalignment solution and the second filtered photoalignment solution comprises exposing the first filtered photoalignment solution and the second filtered photoalignment solution to the green laser.

14. The method of claim 12, wherein exposing the first filtered photoalignment solution and the second filtered photoalignment solution comprises exposing one of the first filtered photoalignment solution and the second filtered photoalignment solution to a left-handed circularly polarized (LCP) beam and exposing another of the first filtered photoalignment solution and the second filtered photoalignment solution to a right-handed circularly polarized (RCP) beam.

15. The method of claim 12, wherein:
a writing angle of the two-beam recording system is half of an intersection angle of beams of the two-beam recording system,
a first writing angle used to expose the first filtered photoalignment solution is different from a second writing angle used to expose the second filtered photoalignment solution, and
the first writing angle corresponds to a first x-axis grating period of the first patterned LC element and the second writing angle corresponds to a second x-axis grating period of the second patterned LC element, the first x-axis grating period and the second x-axis grating period are different.

16. The method of claim 11, wherein forming each of the first patterned LC element and second patterned LC element comprises:
preparing a LC precursor mixture that includes a chiral agent, an initiator, and a photocurable monomer diluted in toluene;
treating the LC precursor mixture with ultrasound sonification to form a treated LC precursor mixture;
coating the treated LC precursor mixture onto an underlying layer to form a respective coated layer;
curing the respective coated layer with ultraviolet light; and
repeating the coating and curing until a predetermined thickness is achieved for the respective first patterned LC element and second patterned LC element.

17. The method of claim 11, wherein forming the interstitial layer comprises:
cleaning a surface of the first patterned LC element on which the interstitial layer is to be deposited;
preparing a silane-based interstitial layer solution;
coating the interstitial layer solution on the first patterned LC element to form an uncured interstitial layer;
baking the uncured interstitial layer; and
treating a surface of the uncured interstitial layer after baking to form a super hydrophilic surface.

18. The method of claim 11, wherein forming each of the first PAL, the first patterned LC element, the interstitial layer, the second PAL, and the second patterned LC element comprises spin-coating, dip-coating, chemical vapor deposition, or ink-jet printing a respective material on an underlying layer.

19. A method of fabricating a stacked liquid crystal device, comprising:
depositing a first photoalignment layer (PAL) on a substrate;
forming a first polarization volume grating (PVG) on a first photoalignment layer (PAL), the first PVG having a first grating period;
depositing an interstitial layer on the first PVG, the interstitial layer formed from a different material than the substrate;
treating a surface of the interstitial layer to form a super hydrophilic surface;
depositing a second PAL on the super hydrophilic surface, the super hydrophilic surface matching a surface energy of the second PAL; and
forming a second PVG on the second PAL, the second PVG having a second grating period that is independent of the first grating period.

20. The method of claim 19, wherein the interstitial layer comprises a silane material and has a thickness between about 1 nm and about 100 nm.
